(19) United States
(12) Patent Application Publication
(10) Pub. No.: US 2007/0213173 A1
(43) Pub. Date: Sep. 13, 2007

(54) Device For Actuating A Gearshift Element

(76) Inventors: Manfred Guggolz, Rutesheim (DE); Werner Hillenbrand, Neuffen (DE); Mario Kaller, Friedrichshafen (DE); Markus Veit, Pliezhausen (DE)

Correspondence Address: WILLIAM COLLARD;COLLARD & ROE, P.C., 1077 NORTHERN BOULEVARD, ROSLYN, NY, 11576, US

(21) Appl. No.: 11/587,616

(22) PCT Filed: Apr. 14, 2005
(86) PCT No.: PCT/EP05/03942

§ 371 Date: Nov. 29, 2006

(30) Foreign Application Priority Data
Apr. 27, 2004 (DE) 10 2004 020 437.3

(51) Int. Cl. B60W 10/10

(52) U.S. Cl. 477/34

(57) ABSTRACT

The invention is based on a device for activating a gear shift element (10) of a motor vehicle by means of a control pressure (p) which is provided for deflecting the gear shift element (10) from a resting position.

It is proposed that a control unit (11) be provided for measuring, at least in one operating state, a characteristic variable (T) to determine a reaction of the gear shift element (10) to a change in the control pressure (p).

The invention relates to a device for activating a gear shift element according to the preamble of claim 1, and to a method for activating a gear shift element according to the preamble of claim 11.

The invention is based on the object of making available a device which permits a function of a gear shift element to be checked with little structural outlay.

In automatic motor vehicle transmissions or in automatic units for motor vehicle transmissions it is generally customary to use a device for activating a gear shift element by means of a control pressure. The gear shift element is usually connected to a piston which can move in a master cylinder and can be provided for selecting a shift gate of a shiftable transmission or for shifting a gear speed. A hydraulic or pneumatic pressure is applied to the master cylinder. In addition it is known to equip devices of the generic type with a pressure sensor which is provided for checking fault-free functioning of the gear shift element. A drop in pressure which is caused, for example, by a failure of a pump generating the pressure can then be sensed and corresponding emergency measures can be taken without the possibility of the motor vehicle transmission and/or the device being damaged.

The invention is based on a device for activating a gear shift element of a motor vehicle by means of a control pressure which is provided for deflecting the gear shift element from a resting position.

It is proposed that a control unit be provided for measuring, at least in one operating state, a characteristic variable to determine a reaction of the gear shift element to a change in the control pressure. As a result, a malfunction in the device can be revealed by means of the characteristic variable. The characteristic variable can be provided by a signal from existing sensors. As a result, it is advantageously possible to dispense with separate sensors for detecting a malfunction in the device.

The term “provided” is also to be understood in this context as meaning “configured” and “equipped”. The characteristic variable can be measured by a sensor unit which is integrated into the control unit or by a sensor unit which is independent of the control unit.

In a further refinement of the invention it is proposed that the control unit be provided for measuring, at least in one operating state, a characteristic variable for an adjustment speed of the gear shift element. As a result, from the characteristic variable it is advantageously possible to draw conclusions about the adjustment speed, which permits a malfunction of the device to be determined particularly immediately.

In addition it is proposed that the control unit be provided for measuring at least one characteristic variable for a resetting speed of the gear shift element. As a result, particularly reliable information about troublefree functioning of the device, in particular of pressure-generating assemblies and pressure valves of the device, can be achieved.

A characteristic variable which can be measured with particularly little structural outlay is a resetting time. However, in principle other characteristic variables which appear appropriate to a person skilled in the art for determining the reaction of the gear shift element to the change in the control pressure and in particular for a variation over time in the deflection after the change are also conceivable.

If the control unit is provided for determining the control pressure from the measured characteristic variable, it is possible to ensure that a faulty control pressure, which can be caused, for example, by a malfunction in a pressure-generating assembly and/or a valve, can be detected immediately. In particular, if the control pressure is derived from a pressure reservoir from which other control pressures for activating further units can also be derived, a drop in the control pressure can, for example, advantageously indicate a possible malfunction of the other units and corresponding countermeasures can be taken.

In this context, a particularly flexible use of the control unit in conjunction with various types of shift units and/or characteristic variables can be achieved if the device comprises a memory unit for storing an assignment table for assigning the characteristic variable to the control pressure.

If the control unit is provided for comparing the control pressure determined from the characteristic variable with an extreme control pressure, it may be advantageously possible to detect when the pressure drops below a minimum pressure or exceeds a maximum pressure.

If the gear shift element is provided for shifting an automatic motor vehicle transmission, increased operational reliability can be achieved and damage to the motor vehicle transmission by a malfunction can be avoided.

In this context, it is possible to avoid setting a faulty shift gate position if the gear shift element is provided for shifting a shift gate position of the automatic motor vehicle transmission. However, the use of the device according to the invention is basically conceivable in conjunction with any gear shift element which appears appropriate to a person skilled in the art.

Further advantages emerge from the description of the figures. The drawing illustrates an exemplary embodiment of the invention. The claims, the figures and the description contain a plurality of features in combination. A person skilled in the art will also consider these individually and combine them to form expedient further combinations.

In said drawing:

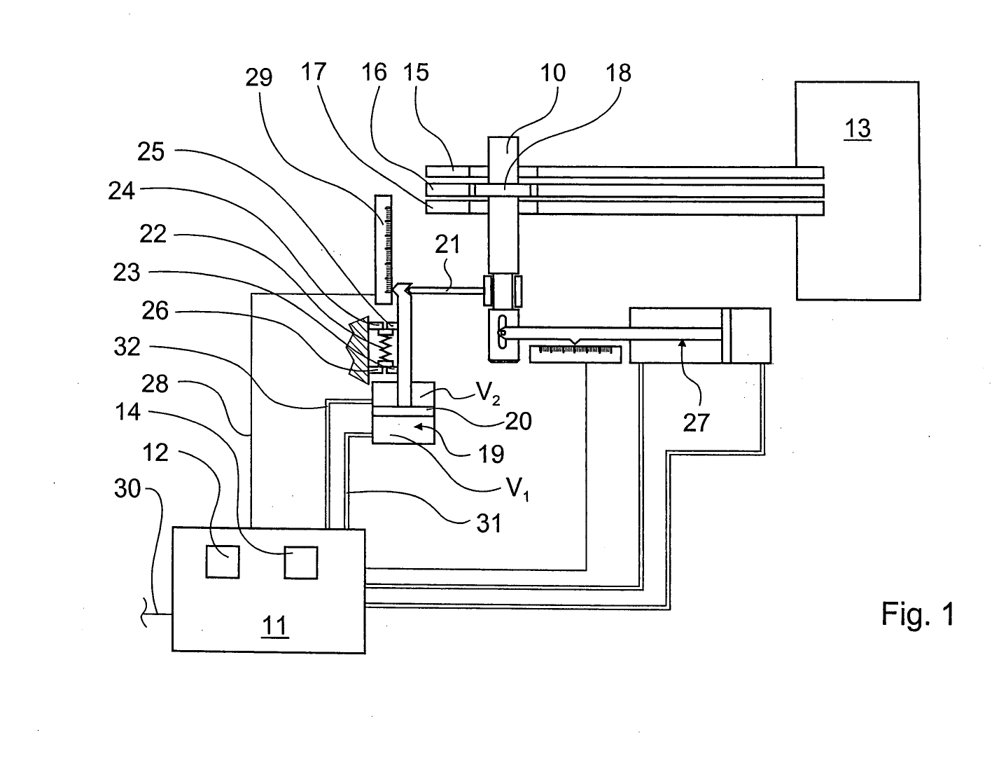

FIG. 1 shows an automatic device of a motor vehicle transmission in a schematic illustration, and

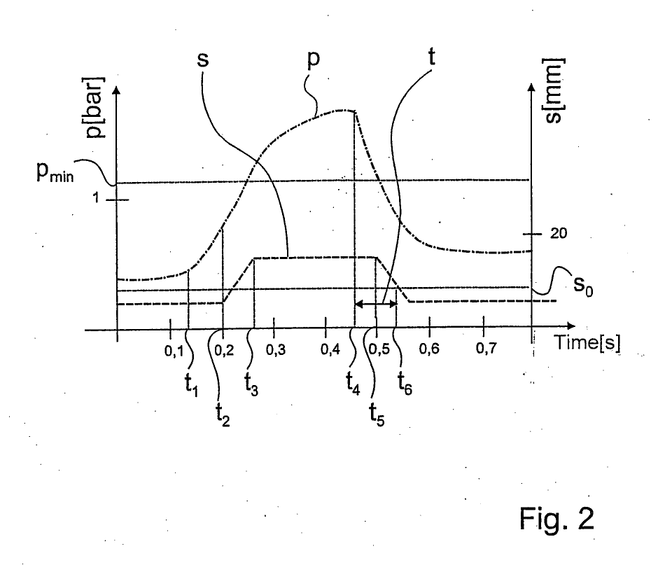

FIG. 2 shows a variation over time in a control pressure and in an axial deflection of a shift shaft from a resting position during a testing process.

FIG. 1 shows an automatic device for automatically activating a gear shift element 10, embodied as a shift shaft, of a motor vehicle transmission 13. The shiftable motor vehicle transmission 13 can be activated in a known fashion by displacing in each case one of three shift rails 15-17. For this purpose, the gear shift element 10 has a shift finger 18 which can be engaged with a recess in one of the three shift rails 15-17 by axially displacing the gear shift element 10. A rotation of the gear shift element 10 is transmitted by the shift finger 18 into a displacement of the shift rail 15-17 with which the shift finger 18 is engaged. The corresponding shift rail 15-17 displaces a toothing in the motor vehicle transmission 13 and as a result a transmission ratio which is dependent on the selection of the shift rail 15-17 and a direction of the rotation occurs at the motor vehicle transmission 13.

A shift gate cylinder 19 comprises a piston 20 which is connected to the gear shift element 10, specifically in such a way that the gear shift element 10 which is embodied as a shift shaft is mounted in a rotatable but axially secured fashion to a connecting element 21 which is connected to the piston 20, and that an axial displacement of the piston 20 in the shift gate cylinder 19 brings about an axial displacement of a shift gate position s of the gear shift element 10 which is the same in absolute terms. The shift gate cylinder 19 has connecting points for two pressure lines 31, 32 by means of which a hydraulic control pressure p can be applied to a volume V₁ or a volume V₂ above or below the piston 20 of the shift gate cylinder 19. A control unit 11 activates valves by means of which the control pressure p can be applied to the volumes V₁, V₂. The piston 20 of the shift gate cylinder 19 additionally interacts with a shift gate spring 22 which is embodied as a compression spring. The shift gate spring 22 stabilizes a resting position of the gear shift element 10 in which the shift finger 18 engages with the second shift rail 16 by means of which a first or a second gear speed of the motor vehicle transmission 13 can be engaged by rotating the gear shift element 10.

If the control unit 11 causes the control pressure p to be applied to the volume V₁ by opening a first valve, while the volume V₂ is vented, the piston 20 is displaced in a first direction as far as a stop on an end side of the shift gate cylinder 19. The gear shift element 10 which is connected to the piston 20 is also displaced axially, specifically to such an extent that the shift finger 18 engages with a first shift rail 15 which is assigned to a third and fourth gear speed of the motor vehicle transmission 13. Here, the force which is exerted by the control pressure p on the piston 20 counteracts a resetting force of the shift gate spring 22. The shift gate spring 22 is compressed by a first driver element 23 which is connected to the piston 20 and by a second driver element 24 which is connected to a housing of the motor vehicle transmission 13.

If the control unit 11 causes the control pressure p to be applied to the volume V₂ by opening a second valve, while the volume V₁ is vented, the piston 20 is displaced in an analogous fashion in a second axial direction as far as a stop on a second end side of the shift gate cylinder 19. The gear shift element 10 which is connected to the piston 20 is also displaced axially, specifically to such an extent that the shift finger 18 engages with a third shift rail 17 which is assigned to a reverse gear speed of the motor vehicle transmission 13. Here, the force which is exerted on the piston 20 by the control pressure p counteracts a resetting force of the shift gate spring 22. The shift gate spring 22 is compressed by a third driver element 25 which is connected to the piston 20, and by a fourth driver element 26 which is connected to a housing of the motor vehicle transmission 13, during which process the first driver element 23 and the second driver element 24 are released by the shift gate spring 22.

In an analogous fashion, the control unit 11 is provided for activating a gear speed cylinder 27 which comprises a piston which is connected fixed in terms of rotation to the gear shift element 10. By opening and/or closing further valves, the control unit 11 causes the piston in the gear speed cylinder 27 to be displaced, which displacement is translated into a rotation of the gear shift element 10. The rotation of the gear shift element 10 is translated by the shift finger 18, as described above, into a displacement of that shift rail 15-17 with which the shift finger 18 is in engagement.

The control unit 11 is additionally connected via a sensor line 28 to a shift gate sensor 29 which senses an axial shift gate position s of the piston 20 or of the gear shift element 10 and passes it on to the control unit 11. In addition, the control unit 11 has an interface 30 by means of which it communicates with other units of the motor vehicle comprising the automatic device and via which it can receive control signals.

If the control unit 11 receives, via the interface 30, a control signal which is provided for starting a pressure-measuring program, a programmable computing unit of the control unit 11 starts a pressure-measuring program which is implemented in the computing unit.

The sequence of the pressure-measuring program is different depending on whether or not a gear speed of the motor vehicle transmission 13 is engaged.

If there is no gear speed of the motor vehicle transmission 13 engaged, the control unit 11 opens the first valve at a first time t₁ (FIG. 2) and vents the first volume V₁ to the control pressure p. In the process, the control pressure p rises to its saturation value within a filling time of approximately 300 ms through the finite throughflow cross section of the valve. At a second time t₂, the force exerted on the piston 20 by the control pressure p exceeds a prestressing force of the shift gate spring 22, after which the gear shift element 10 is deflected from its resting position. The piston 20 and the gear shift element 10 are displaced in the first axial direction until the piston 20 strikes against the end side of the shift gate cylinder 19 at a time t₃. The control unit 11 has then deflected the gear shift element 10 for test purposes. If the filling time has passed, the control unit 11 opens an outlet valve at a time t₄ and vents the volume V₁. A time-measuring unit 14 of the control unit 11 begins to measure a time starting at the time t₄. In this context, the control pressure p is greater up to a time t₅ than the spring force generated by the shift gate spring 22 in the stop configuration which resets the piston 20 and the gear shift element 10 to its resting position in the time interval following the time t₅.

At a time t₆, the shift gate position s which is sensed by the shift gate sensor 29 drops below a threshold value so which is stored in a memory unit 12 of the control unit 11, and the time-measuring unit 14 stops the time measurement. The control unit 11 stores the value measured by the time-measuring unit 14 as a characteristic variable T in the memory unit 12.

If there is no gear speed of the motor vehicle transmission 13 engaged, the control unit 11 starts an analogous pressure-measuring program in which, in contrast to the method described above, the piston 20 does not strike against the end side of the shift gate cylinder 19 but rather the shift finger 18 moves within a degree of play in the recess in that shift rail 15-17 with which the shift finger 18 is currently in engagement. In the process, the shift gate position s correspondingly changes only by a few millimeters. Depending on the engaged gear speed of the motor vehicle transmission 13, the control unit 11 applies a threshold value so which is adapted to the gear speed. The value which is determined by the time-measuring unit 14 is multiplied by the control unit 11 by a correction factor which takes account of the different filling volumes of the individual gear speeds. The control unit 11 utilizes the corrected value as a characteristic variable T.

The characteristic variable T characterizes the reaction of the gear shift element 10 to the change in the control pressure p in the volume V₁, and at the time t₄. Since the time which the gear shift element 10 requires to reach the threshold value s₀ is determined by an adjustment speed of the gear shift element 10, the value which is determined by the time-measuring unit 14 is at the same time a characteristic variable T for the adjustment speed or for a resetting speed of the gear shift element 10. The characteristic variable T designates more precisely a resetting time.

An assignment table from which the computing unit of the control unit 11 can read out a stored value as a function of the measured characteristic variable T is stored in the memory unit 12 of the control unit 11, said stored value representing the control pressure p which usually leads to the measured characteristic variable 10 being measured. As a result, the control unit 11 assigns the measured characteristic variable T to the control pressure p. The control pressure p which is determined is made available by the control unit 11 via the interface 30 for the CAN bus of the motor vehicle.

After the control pressure p has been determined, the control unit 11 compares the control pressure p with an extreme control pressure pₘᵢₙ which is stored in the memory unit 12 and which represents a minimum value. If the control pressure p which is determined is smaller than the extreme control pressure pₘᵢₙ, the control unit 11 makes a corresponding fault information item available via the CAN bus and said item causes an emergency mode of the motor vehicle to be switched on.

Further refinements of the invention are conceivable in which the time-measuring unit 14, instead of the time interval between the times t₄ and t₆, determines a different time interval which appears appropriate to a person skilled in the art. In addition, it is conceivable for the control unit 11 to be provided for deflecting the gear shift element 10 slightly by means of a small change in pressure in one of the volumes V₁, V₂, specifically without the piston 20 or the shift finger 18 coming to bear. From the reaction of the shift gate which is determined by means of the shift gate sensor 29 it is possible for the control unit 11 to draw conclusions about the rigidity of the system and thus about the control pressure p by means of an assignment table which is stored in the memory unit 12.

### REFERENCE SYMBOLS

10 Gear shift element
11 Control unit
12 Memory unit
13 Motor vehicle transmission
14 Time-measuring unit
15 Shift rail
16 Shift rail
17 Shift rail
18 Shift finger
19 Shift gate cylinder
20 Piston
21 Connecting element
22 Shift gate spring
23 Driver element
24 Driver element
25 Driver element
26 Driver element
27 Gear speed cylinder
28 Sensor line
29 Shift gate sensor
30 Interface
31 Pressure line
32 Pressure line
p Control pressure
T Characteristic variable
pₘᵢₙ Extreme control pressure
s₀ Threshold value
s Shift gate position
t₁ Time
t₂ Time
t₃ Time
t₄ Time
t₅ Time
t₆ Time
V₁ Volume
V₂ Volume

1. A device for activating a gear shift element (10) of a motor vehicle by means of a control pressure (p) which is provided for deflecting the gear shift element (10) from a resting position, wherein a control unit (11) is provided for measuring, at least in one operating state, a characteristic variable (T) to determine a reaction of the gear shift element (10) to a change in the control pressure (p).

2. The device as claimed in claim 1, wherein the control unit (11) is provided for measuring, at least in one operating state, a characteristic variable (T) for an adjustment speed of the gear shift element (10).

3. The device as claimed in claim 1, wherein the control unit (11) is provided for measuring at least one characteristic variable (T) for a resetting speed of the gear shift element (10).

4. The device as claimed in claim 3, wherein the characteristic variable (T) is provided by a resetting time.

5. The device as claimed in claim 1, wherein the control unit (11) is provided for determining the control pressure (p) from the measured characteristic variable (T).

6. The device as claimed in claim 5, comprising a memory unit (12) for storing an assignment table for assigning the characteristic variable (T) to the control pressure (p).

7. The device as claimed in at least claim 5, wherein the control unit (11) is provided for comparing the control pressure (p) determined from the characteristic variable (T) with an extreme control pressure (pₘᵢₙ).

8. The device as claimed in claim 1, wherein the gear shift element (10) is provided for shifting an automatic motor vehicle transmission (13).

9. The device as claimed in claim 8, wherein the gear shift element (10) is provided for shifting a shift gate position (s) of the automatic motor vehicle transmission (13).

10. The device as claimed in claim 1, wherein the control unit (11) is provided for deflecting the gear shift element (10) for test purposes.

11. A method for activating a gear shift element (10) of a motor vehicle by means of a control pressure (p), wherein, at least in one operating state, a characteristic variable (T) is measured to determine a reaction of the gear shift element (10) to a change in the control pressure (p).
